(19) United States
(12) Patent Application Publication
(10) Pub. No.: US 2026/0271816 A1
(43) Pub. Date: Sep. 17, 2026

(54) SOIL TILLAGE DEVICE

(71) Applicant: AMAZONEN-WERKE H. DREYER SE & CO. KG, Hasbergen (DE)

(72) Inventors: Stefan Jan Johannaber, Lienen (DE); Florian Stein, Osnabrueck (DE); Thomas Wessels, Osnabrueck (DE); Philipp Stark, Osnabrueck (DE)

(21) Appl. No.: 19/470,933

(22) PCT Filed: Mar. 27, 2024
(86) PCT No.: PCT/EP2024/058188

§ 371 Date: Sep. 30, 2025

(30) Foreign Application Priority Data
Apr. 5, 2023 (DE) 10 2023 108 711.8

(51) Int. Cl. A01B 49/02; A01B 63/111

(52) U.S. Cl. CPC A01B 49/027; A01B 63/1115

(57) ABSTRACT

The invention relates to a soil tillage device for tillage of an agricultural area (N), which is movable relative to the agricultural area (N), with a plurality of working tools (3) arranged on a tool frame (2) and engaging with the agricultural area (N), and at least one clogging sensor (4) for detecting material accumulations (M) that are dragged along by the working tools (3) and impair the soil tillage, wherein the clogging sensor (4) is coupled to a touch element (4.1) arranged movable relative to the tool frame (2) for tactile detection of the material accumulations (M).

The present invention relates to a soil tillage device for tillage of an agricultural area, which is movable relative to the agricultural area, with a plurality of working tools arranged on a tool frame and engaging with the agricultural area, and at least one clogging sensor for detecting material accumulations that are dragged along by the working tools and impair the soil tillage. Another subject of the invention is a method for tillage of an agricultural area with a soil tillage device.

Agricultural areas, such as acres, fields or meadows, are often tillaged with various soil tillage devices during a tillage cycle. Such soil tillage devices can be used to loosen, refine, aerate, or otherwise prepare the soil of the agricultural area for subsequent agricultural tillage steps, such as, in particular, the sowing of crops. Soil tillage devices designed as direct seed drills are also known, which tillage the soil and deposit seeds in a single step. In addition, such soil tillage devices are used to incorporate organic materials, such as crop residues, weeds, or fertilizer, into the agricultural area.

In such soil tillage devices, several working tools are usually arranged on a common tool frame, for example offset next to and/or behind each other. The working tools usually engage with the agricultural area to a certain working depth for soil tillage. For tillage of the respective agricultural area, such soil tillage devices are often moved across the agricultural area by means of a tractor unit along essentially parallel tracks. This typically causes a certain amount of soil movement via the working tools that penetrate the agricultural area. To move relative to the agricultural area, the soil tillage devices can be attached or mounted on an agricultural tractor unit or, alternatively, be self-propelled. In agricultural practice, depending on the nature of the agricultural area and the settings of the respective soil tillage device, it may happen that material located on the agricultural area, such as organic material like plant residues or piles of earth, is dragged along, collected, and piled up by the working tools during soil tillage. Such undesirable material accumulations, which are often difficult for the operating personnel to see due to the size of the device and possible obstructions to visibility caused by dust or similar factors, can clog the working tools and impair soil tillage under unfavorable conditions. In this case, the material accumulation can lead to undesirable unevenness and/or incomplete tillage of the tillaged agricultural area.

Furthermore, such soil tillage devices are increasingly highly automated or are pulled across the agricultural area by autonomously driving tractor units, for example. In this case, there is usually no operating personnel on site who could detect material accumulations or clogging of the working tools, so that operator-independent detection of material accumulations is necessary.

In order to be able to detect material accumulations in a timely manner and independently of the operator before a critical clogging occurs, it is known in the prior art to equip such soil tillage devices with non-contact clogging sensors for detecting material accumulations. DE 10 2004 031 819 A1 describes a soil tillage device that has several ultrasonic sensors for detecting material accumulations in the area of the working tools. DE 10 2017 112 224 A1 discloses a soil tillage device in which radar sensors are used as clogging sensors.

In such known soil tillage devices with contactless clogging sensors, malfunctions and/or failures of the clogging sensors can occur under unfavorable working conditions. Since such sensors usually require an unobstructed line of sight to the agricultural area, visual obstructions such as dust and/or deposits of dirt and contaminants on the clogging sensors can lead to detection errors. In addition, the often adverse environmental conditions of agricultural soil tillage can lead to failures of such sensitive, contactless sensors. As a result, cloggings may not be detected at all or may only be detected by neighboring sensors once they have reached a certain extent.

Against this background, the invention sets itself the task of providing a soil tillage device that enables reliable and timely detection of material accumulations that interfere with soil tillage, even under unfavorable environmental conditions.

This task is solved in a soil tillage device of the above-mentioned type by the features of patent claim 1. Advantageous further developments are specified in the dependent subclaims.

The clogging sensor is coupled to a touch element that can be moved relative to the tool frame for tactile detection of material accumulations. Such a design allows reliable and rapid detection of material accumulations by contact with the touch element, even under adverse environmental conditions.

In a further development of the invention, it is proposed that the touch element is movably arranged between a normal position and a detection position indicating a material accumulation. Such a design allows reliable detection of material accumulations. Furthermore, such a design allows for a simple measurement and control design and layout of the clogging sensor. It has proven to be particularly advantageous if the touch element is rotatable or pivotable between the normal position and the detection position. The touch element can be rotatable or pivotable between the normal position and the detection position, preferably by an angle of about 5 to 40 degrees, more preferably 10 to 25 degrees, and most preferably 10 to 20 degrees, in particular 15 degrees. Such values are advantageous because small deflections, for example due to earth movement common during soil tillage, are already mechanically filtered out. This improves the signal and detection quality.

In this context, it has proven advantageous from a design perspective if the touch element can be moved into the detection position by contact with a material accumulation. Such a design enables simple and error-free detection of material accumulations. Here, the touch element can, for example, be arranged and designed in such a way that it is carried along or dragged along by the material accumulation. Direct coupling of the material accumulation to be detected with the touch element allows for immediate, time-saving detection. Furthermore, such a design can prove to be particularly maintenance and repair friendly.

In this context, it has proven advantageous if the clogging sensor is designed for detection of the detection position and/or the normal position of the touch element. Such a design enables reliable and time-saving detection of material accumulations. With regard to increased reliability of clogging detection, the clogging sensor can be designed in particular to detect the normal position of the touch element. Any deviation from the normal position can trigger a signal from the clogging sensor in such a design. In this way, deviations of the touch element from the normal position that were not triggered by a material accumulation can also be detected. In addition, with such a design, defects or faults in the clogging sensor and/or the cabling, such as cable breaks, can also be reliably detected.

It is also proposed that the touch element can be moved between the normal position and the detection position against the force of a tensioned spring. Such a design allows the spring to compensate for vibrations or oscillations occurring during soil tillage. This results in robust detection of material accumulations regardless of any vibrations or oscillations of the soil tillage device, for example as a result of uneven ground. Furthermore, the sensitivity of the touch element can be adjusted by changing the preload force of the spring. This allows the sensitivity of the clogging detection to be adjusted, whereby a low spring force tends to result in higher sensitivity and vice versa. The trigger force of the touch element can be adjusted via the spring preload. In addition, a suitably selected spring preload can reduce or even eliminate any material accumulation via the touch element. Furthermore, the touch element can also be movable against the force of another return element, for example a hydraulic return element.

In an advantageous further development of the invention, it is proposed that the touch element be arranged at a distance from the agricultural area. Such an arrangement allows unhindered soil tillage while simultaneously detecting excessive material accumulations and cloggings that interfere with soil tillage. Preferably, the distance between the touch element and the agricultural area can be adjusted.

This allows the clogging detection to be adapted to the properties of the agricultural area or the requirements of soil tillage, such as the uniformity and flatness of the agricultural area. In particular, adjusting the distance between the touch element and the agricultural area allows a balance to be achieved between the requirements for soil tillage that is as fast and trouble-free as possible and early, reliable detection of critical material accumulations.

In this context, from a design perspective, it is preferable for the touch element to be positioned at a distance from the tool frame in the normal position which is at least one third, preferably about half, of the passage height between the tool frame and the working tool. Alternatively, however, the touch element may also be positioned at a distance from the tool frame which is one third, one quarter, one fifth, or another proportion of the passage height between the tool frame and the working tool, if this proves to be advantageous in the respective soil tillage application.

From a design perspective, it has proven advantageous for the touch element to interact with a stop in the normal position. This results in a defined normal position of the touch element. This allows the normal position to be clearly defined even under shock or vibration. In particular, the stop can be designed to be adjustable.

It is also proposed that the touch element is operatively connected to an actuator for reducing a detected material accumulation. With such a design, material accumulation can be actively reduced or removed via the touch element operatively connected to an actuator. In particular, a hydraulic actuating element may be provided as the actuator, via which the touch element may be movable, in particular pivotable, to reduce material accumulation. In this case, the touch element may be movable via the actuator, for example, in a vibrating or oscillating manner, so that material accumulations in contact with the touch element can be removed or loosened.

From a sensor technology perspective, it is preferable for the clogging sensor to be designed as a proximity or sensing sensor. Such a design enables reliable and maintenance-friendly detection of material accumulations. In particular, the clogging sensor can be adapted to the conditions of the soil tillage device or the environmental conditions and can be designed as an inductive or capacitive sensor, for example. Depending on the design and arrangement of the clogging sensor, distance sensors, rotation angle sensors, inclination sensors, reed switches, or other measuring sensors may prove to be advantageous. Furthermore, depending on the application situation, simple switches can also be used as suitable sensor elements in the clogging sensor.

Another structurally advantageous design provides that the touch element is designed as a touch lever mounted pivotable about a rotation axis. A touch lever arranged in this way can be moved in a kinematically simple manner via a pivoting movement between the normal position and the detection position. In this context, it is preferable for the rotation axis to extend transversely to the working direction. This makes it particularly easy for the touch lever to be carried away by a material accumulation. The touch lever can be designed in particular in the form of a rod, for example in the form of tines like a harrow, and can be straight or curved. Round tines in particular have proven to be advantageous in terms of reducing material adhesion. In order to increase the potential contact area of the touch lever with a material accumulation, a touch lever can have two or more tines arranged in particular parallel to each other. A further increase of the contact area is possible by means of angled tines. As an alternative to a design with rod-shaped tines, touch levers that are at least partially plate-or paddle-shaped can also be used.

With regard to the arrangement of the touch lever, it is proposed that this be angled relative to the agricultural area. Preferably, the touch lever extends in the direction of the agricultural area. In this configuration, the touch lever is arranged in a favorable, low-wear manner on a drag, which makes it easier for the touch lever to be dragged along or carried along by a material accumulation. It has proven advantageous to form a sharp angle of attack between the vertical and the touch lever in its normal position. It is particularly advantageous in terms of adapting the clogging sensor to different environmental and operating conditions if the angle of attack is adjustable.

A design in which the touch lever is detachably attached to a swivel element that can be pivoted around the rotation axis has proven to be advantageous in terms of maintenance. Alternatively, the touch lever and the swivel element can also be designed as a single piece.

In a further development of the invention, it is proposed that the clogging sensor and the swivel element are jointly attached to the tool frame via a frame connection. This results in a structure that is easy to install and maintain. In particular, it can be advantageous in terms of time-saving assembly and/or maintenance if the frame connection is designed as a detachable clamping device. In particular, a detachable frame connection can also enable the retrofitting of machines. Alternatively, it can be advantageous in terms of a reliable connection if the frame connection is designed as a bolt or welded connection.

It is also proposed that the frame connection is attachable to the tool frame in an adjustable manner in order to adjust the angle of attack of the touch lever that determines the normal position. Such a design allows for quick and user-friendly adjustment of the angle of attack. For example, the touch lever may be rotatably arranged about a support of the tool frame in order to adjust the angle of attack.

It may also be advantageous if the touch lever can be moved between the normal position and the detection position against the force of a spring extending between the swivel element and the frame connection. A return element designed as a spring can be used to apply a preload to the touch lever in an advantageous manner, thereby preventing undesirable pivoting of the touch lever, for example as a result of shocks or vibrations of the soil tillage device. Alternatively to a spring, other return elements can also be used.

Another preferred embodiment provides for the spring to be connected to the frame connection via an actuating element for adjusting the preload acting on the touch lever. Such a design allows simple and user-friendly adjustment of the preload acting on the touch lever. The actuating element can enable continuous adjustment of the preload, for example in the form of an adjusting screw, or stepwise adjustment of the preload, for example in the form of a slide with several locking positions.

It is also proposed that the touch lever be connected to a touch element widening in order to increase the touch surface area that comes into contact with material accumulations. Such a touch element widening allows for more reliable detection of material accumulations and improves the response behavior of the touch lever. The touch element widening can, for example, be designed in the manner of a paddle or a plate. Preferably, the touch element widening can be designed to be replaceable.

In an advantageous further development of the invention, it is proposed that the actuator is designed for active pivoting of the touch lever about the rotation axis. Such a design makes it possible to actively pivot the touch lever in order to reduce or remove a material accumulation. The actuator may in particular be designed as a hydraulic or electric actuator, via which the touch lever may be designed to be movable, for example, in a pivoting or vibrating manner.

With such a design, material accumulation can be actively reduced or removed via the touch element connected to an actuator. In particular, a hydraulic actuating element can be provided as an actuator, via which the touch element can be moved to reduce a material accumulation. Here, the touch element can be moved, for example by vibrating or oscillating, in particular pivoting, via the actuator, so that material accumulations in contact with the touch element can be removed or loosened.

An advantageous further development of the invention provides that the clogging sensor for evaluation of the detection position and/or for monitoring of the touching time within which the touch element is in the detection position, is connected to an evaluation unit. This enables reliable and rapid evaluation of the detection position and/or the touching time. The touching time can correlate in particular with the intensity or extent of a clogging.

In this context, it is also proposed that the evaluation unit is designed for generation of a control signal that can be transmitted to a control unit of the soil tillage device and/or a tractor unit connected to the soil tillage device. Such a design has proven to be advantageous in terms of control technology and allows the soil tillage to be adjusted depending on the signals from the clogging sensor. In particular, the evaluation unit and the control unit can be designed as a single structural unit, which facilitates retrofitting on existing soil tillage devices. Alternatively, the evaluation unit and the control unit can also be designed separately. Furthermore, it has proven advantageous for the evaluation unit to have a filter for filtering interference signals that may result from shocks or vibrations, for example. The evaluation and/or control unit may be part of an autonomous or automatic control system for the soil tillage device and/or the tractor unit.

Advantageously, the mounting position of each touch element and/or each working tool on the tool frame is stored in the evaluation unit and/or control unit. In this way, it is possible to detect the location where material accumulation and/or clogging occurs. Working tools adjacent to each touch element can be assigned. The number of touch elements in the detection position, in particular adjacent or spatially nearby touch elements, can correlate with the intensity and/or extent of a material accumulation and/or clogging. By detecting an increase in the number of touch elements, in particular adjacent or spatially nearby touch elements, in the detection position, it is possible to determine an increase in the intensity and/or extent of the material accumulation and/or clogging. By detecting a decrease in the number, in particular of adjacent or spatially nearby, touch elements in the detection position, a reduction in the intensity and/or extent of the material accumulation and/or clogging can be determined.

In this context, it has proven advantageous if the control signal is designed as a warning signal and/or brake signal and/or stop signal and/or lift signal and/or drive signal depending on the touching time and/or the intensity and/or the extent of a material accumulation and/or clogging. The drive signal can comprise a reverse signal, a forward signal, and/or a steering signal. The various control signals can be used to initiate appropriate measures adapted to the intensity and/or the extent of the clogging, with which clogging can be avoided, reduced, or eliminated. The control signals can relate to the entire soil tillage device or to individual or multiple working tools. By controlling individual working tools, especially taking into account the assignment between the mounting positions of the touch elements and the working tools, a detected clogging can be specifically addressed and locally resolved or reduced at the point of origin.

With regard to particularly accurate control of the soil tillage device, it has proven advantageous if the clogging sensor is designed to detect one or more intermediate positions of the touch element between the normal position and the detection position. This design allows different degrees of material accumulation to be detected. The intermediate positions of the touch element can be detected discretely or continuously. For this purpose, the clogging sensor can be designed, for example, as an inclination sensor, an angle meter, in particular a rotary potentiometer.

By detecting intermediate positions of one or more, in particular adjacent or spatially nearby, touch elements in the detection position, an increase or decrease of the intensity and/or extent of the material accumulation and/or clogging can be determined.

In this context, it is advantageous in terms of control technology if the evaluation unit is designed to generate the control signal depending on the detected intermediate positions of the touch element. This allows the control signals to be precisely adapted to the respective detected intermediate positions.

In a structurally advantageous design of the soil tillage device, the working tools are arranged on the tool frame so that they can pivot against the working direction for overload protection. The overload protection can also be advantageously integrated into the system for processing material accumulations. For example, individual or multiple working tools can be moved by means of hydraulic overload protection depending on the detected material accumulation in order to remove the material accumulation. The movement of the working tools can be simultaneous or coordinated in time.

It is also advantageous if the working tools are distributed across the working width of the soil tillage device. This enables uniform soil tillage across the working width. In particular, the working tools can be arranged at uniform distances across the working width of the soil tillage device.

It is also proposed that the working tools are arranged on several frame elements of the tool frame, preferably extending parallel to each other, to form several working rows. This results in an advantageously compact design of the soil tillage device. Furthermore, applications are conceivable in which the frame elements can extend at an angle to each other.

In this context, it has proven advantageous to arrange the working tools of adjacent processing rows in a staggered manner across the working width so that they each engage with unprocessed agricultural area. This prevents double processing of the agricultural area. In addition, this design reduces the risk of cloggings due to material accumulations between the working tools.

With regard to effective, non-turning soil tillage, it has proven advantageous for the working tools to be designed as cultivator tines.

Another advantageous design provides that a plurality of clogging sensors for detection of material accumulations are distributed across the working width of the soil tillage device. This allows material accumulations to be reliably detected, regardless of their position. Alternatively, the clogging sensors can be arranged at selected locations on the soil tillage device, preferably at locations that have proven to be susceptible to the occurrence of material accumulations.

In this context, it is preferable if the clogging sensors are each arranged on frame elements next to a respective working tool, preferably between two working tools. The result is a design in which occurring material accumulations can be detected reliably and quickly across the entire working width of the soil tillage device.

In this context, a design in which the clogging sensors are each connected to the evaluation unit to generate a control signal is advantageous in terms of control technology. With regard to the precise localization of a material accumulation, it can be advantageous if each clogging sensor is connected separately to the evaluation unit. Alternatively, several clogging sensors can be connected to the evaluation unit in groups. Although this makes it more difficult to locate a material accumulation, it can simplify evaluation and control. A further simplification of evaluation and control can be achieved if all clogging sensors are combined in terms of evaluation and/or control technology.

In a further development of the invention, it is proposed that the evaluation unit generates a control signal when one or more clogging sensors detect a detection position of the respective touch element. Depending on the arrangement and interconnection of the clogging sensors, the sensitivity of the clogging detection can be adjusted via such a design. In soil tillage situations where any clogging must be detected as quickly as possible, the control signal can be generated as soon as the detection position is recognized by a touch element. In cases of soil tillage where cloggings are less critical, it may be sufficient for the evaluation unit to generate a control signal only when several clogging sensors indicate the detection position of the respective touch element.

This also allows the extent of material accumulation at which a control signal is to be generated to be set.

To solve the above-mentioned problem, a method for tillage of an agricultural area with a soil tillage device with a on a tool frame arranged plurality of working tools, engaging the agricultural area and be movable thereto, and at least one clogging sensor for detection of material accumulations dragged along by the working tools and impairing the soil tillage, wherein the material accumulations are detected tactilely by a touch element which is movably arranged relative to the tool frame and coupled to the clogging sensor. This results in the advantages explained in connection with the soil tillage device.

In such a method, it has proven advantageous if the soil tillage device is designed in accordance with one or more of the features described above.

It is also proposed that the clogging sensor is connected to an evaluation unit which generates a control signal when the touch element detects a material accumulation. Such a design enables effective and efficient control intervention when the touch element detects a material accumulation.

In an advantageous further development of the invention, it is proposed that, in order to remedy a clogging caused by the material accumulation, the soil tillage device and/or the tractor unit is braked or stopped in dependence to the control signal and/or that the soil tillage device and/or the working tools are lifted completely or partially from the agricultural area and/or that the working tools and/or the touch elements are actively moved. The measures for remedying a clogging can be adapted in particular to the intensity and/or extent of the clogging. For example, individual or multiple working tools can be moved. The number of working tools moved can depend on the intensity and/or extent of the clogging. The mounting position of the working tool or tools moved can depend on the location of the detected material accumulation. The intensity and/or deflection of the movement of the working tools may depend on the intensity and/or extent of the detected material accumulation. The movement of the working tools may be simultaneous or coordinated in time, depending on the degree and/or location of the detected material accumulation. In the event of a particularly severe, stubborn clogging, it may be advantageous to move the tractor unit with the soil tillage device raised in the opposite direction to the working direction to the point where the clogging sensor has stopped. This ensures effective and reliable removal of stubborn cloggings.

Furthermore, it has proven advantageous in terms of control technology if the measures to remedy a clogging caused by material accumulation are carried out automatically. Such a design has proven particularly advantageous in relation to use with autonomously operating soil tillage devices and/or autonomously operating tractor units.

Further details and advantages of the invention are explained below with the aid of the accompanying drawings of embodiments. These show:

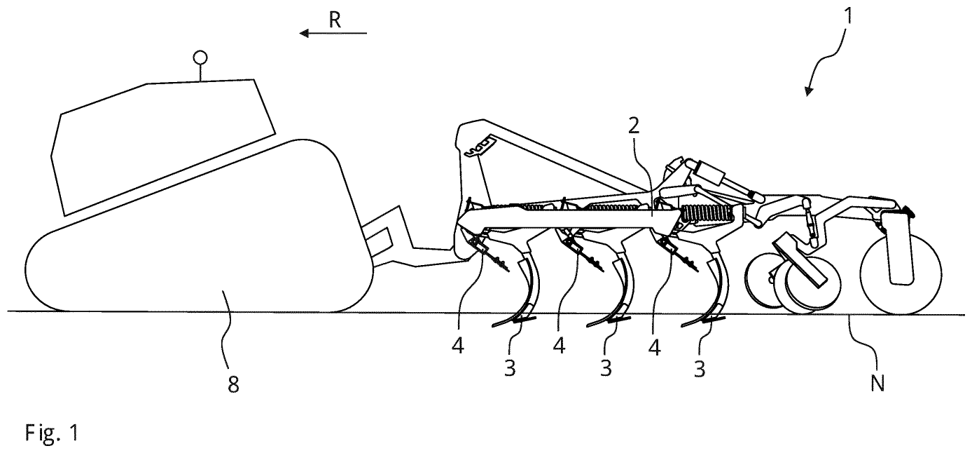

FIG. 1 a side view of a soil tillage device connected to a tractor unit;

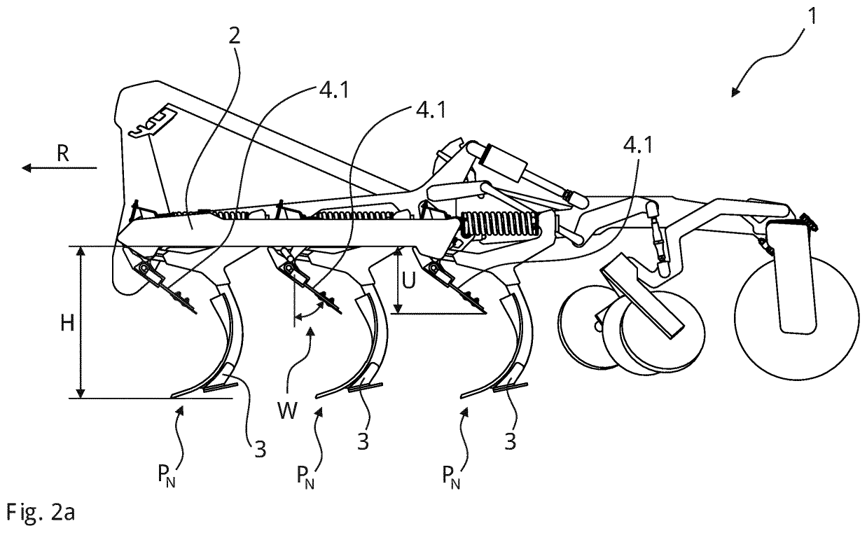

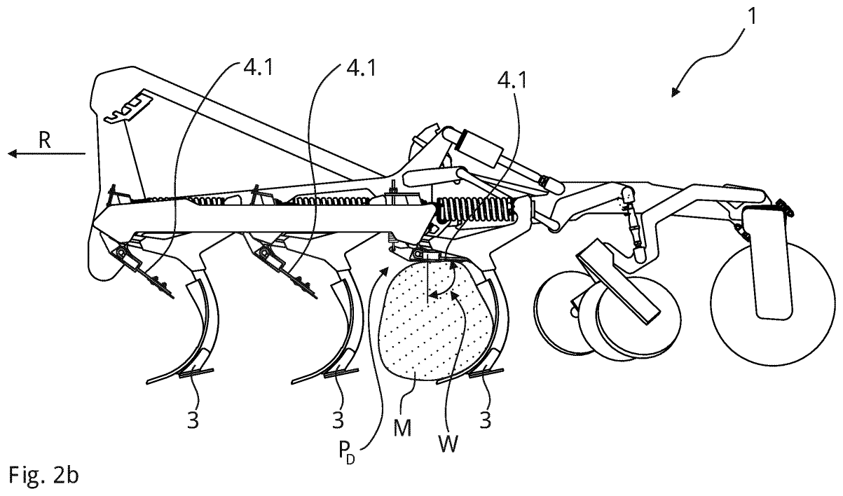

FIGS. 2a and 2b two side views of the soil tillage device as shown in FIG. 1;

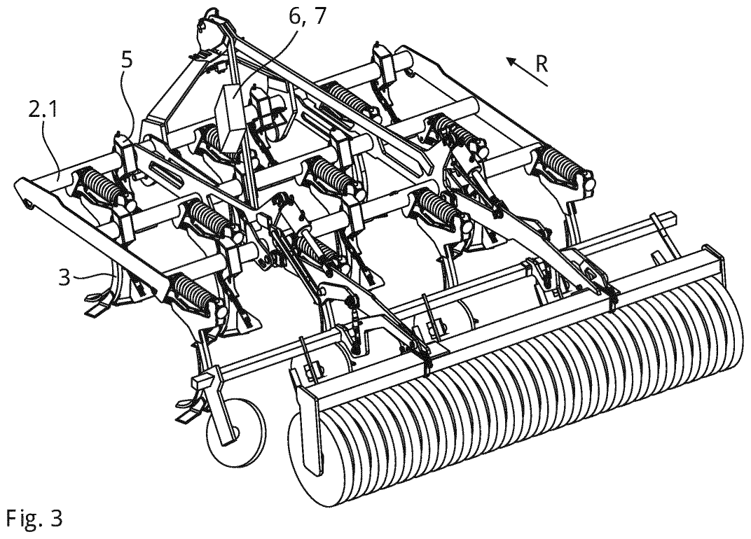

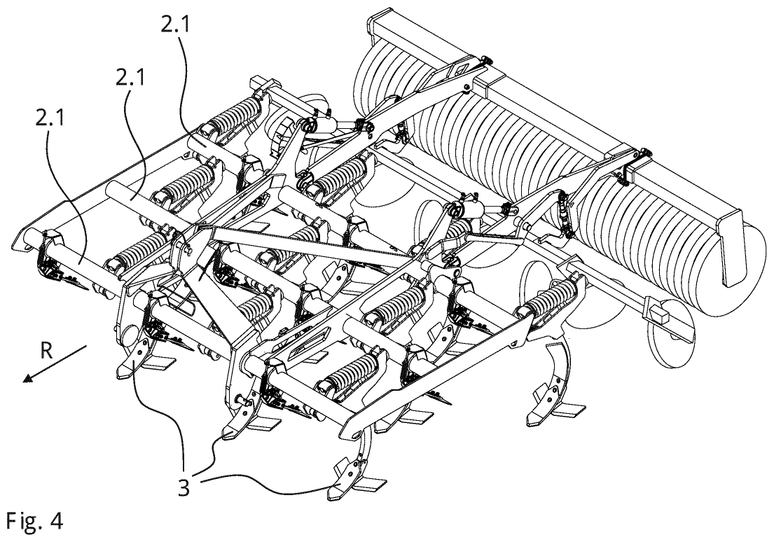

FIGS. 3 and 4 Two Perspective Top Views of the Soil Tillage Device according to FIG. 1;

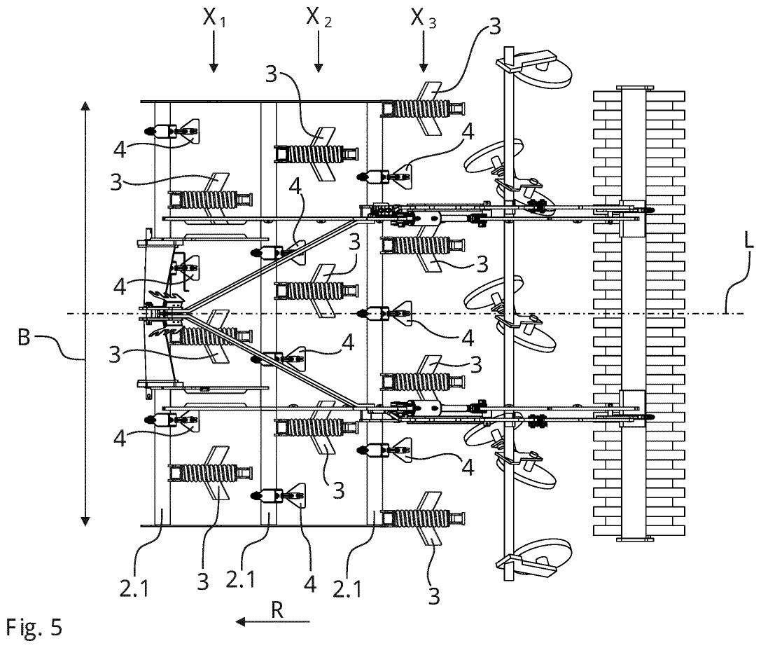

FIG. 5 a top view of the soil tillage device according to FIG. 1;

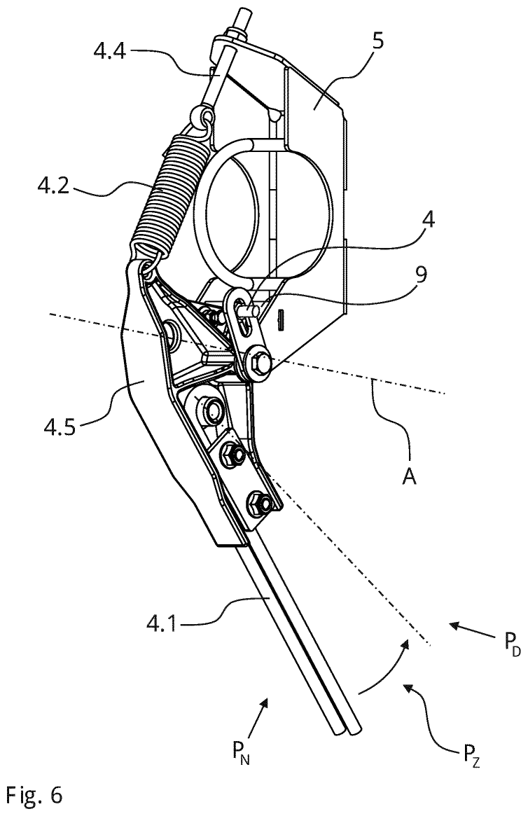

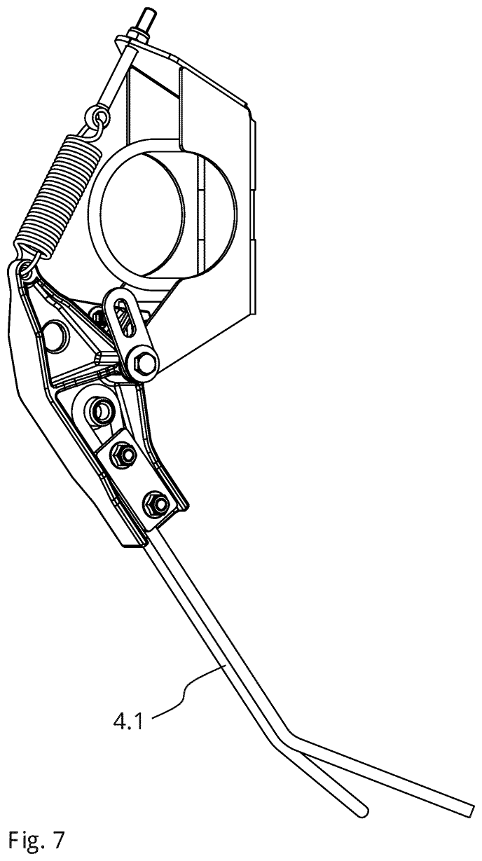

FIGS. 6 to 7 perspective views of two clogging sensors with different touch elements;

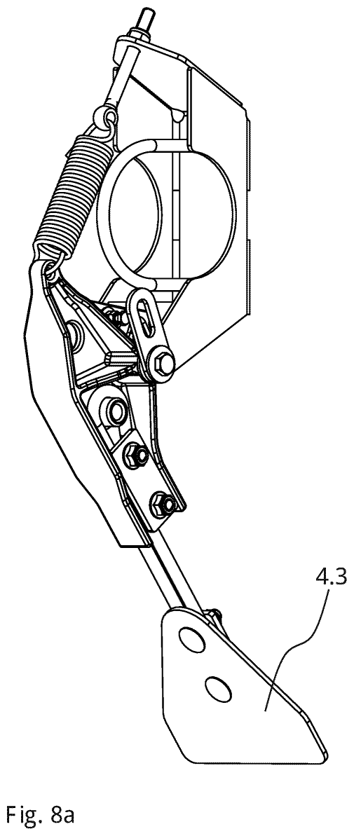

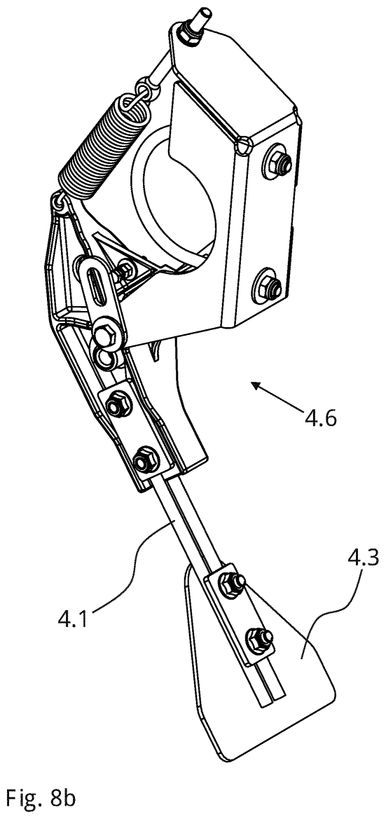

FIGS. 8a and 8b two perspective views of a clogging sensor with an additional touch element;

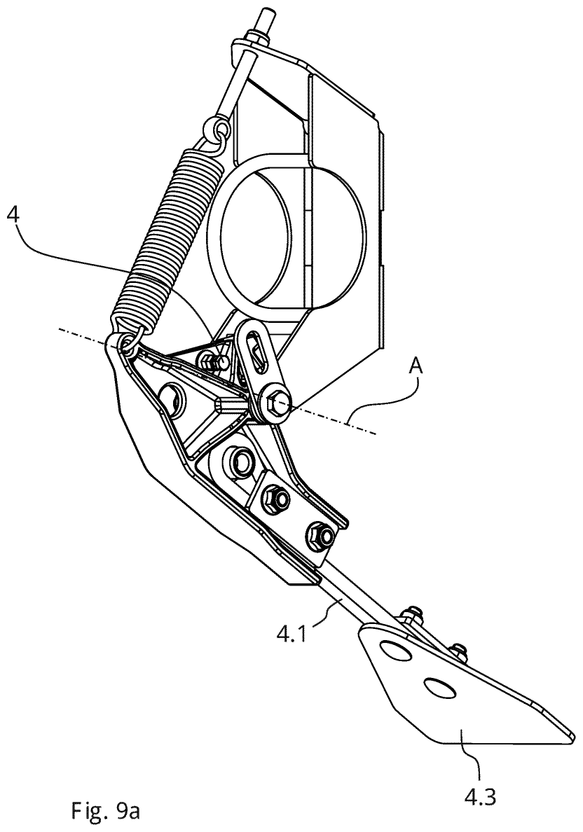

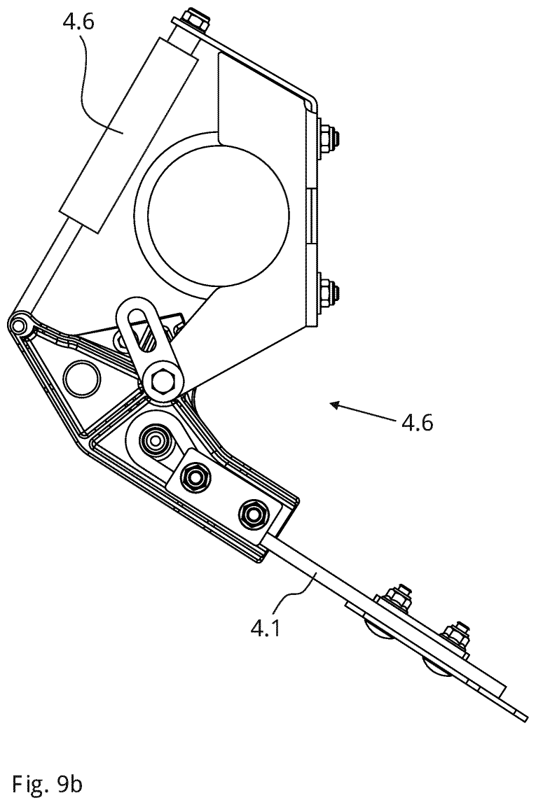

FIGS. 9a and 9b two further partially perspective views of two clogging sensors, and

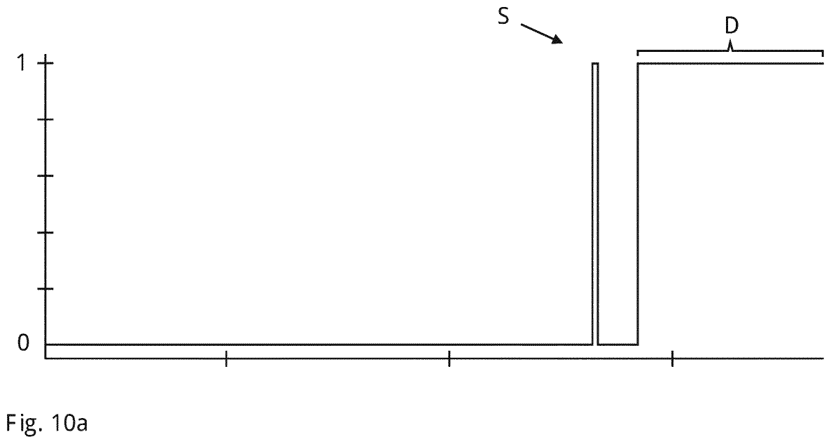

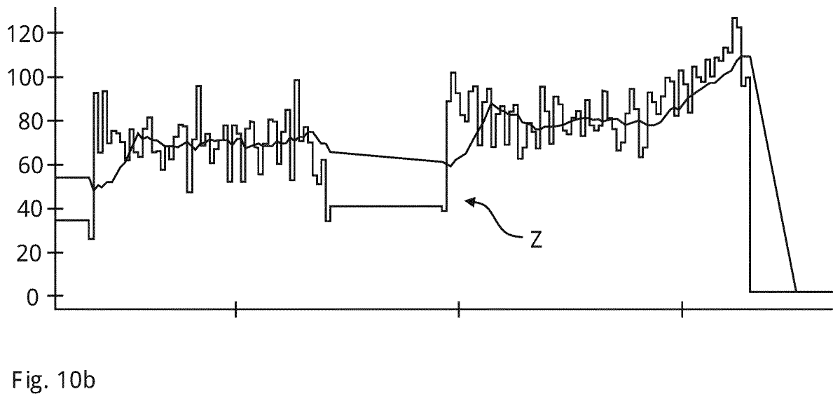

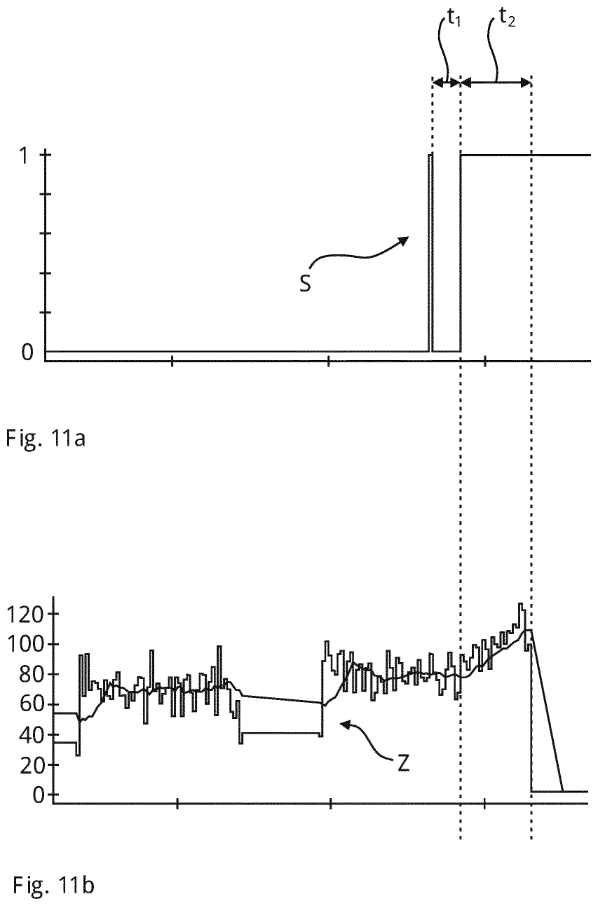

FIG. 10a to 11b schematic representations of an exemplary signal from a clogging sensor (FIGS. 10a and 11a) over time and the towing capacity of the tractor unit (FIGS. 10b and 11b).

The illustration in FIG. 1 shows a side view of a soil tillage device 1, which is connected to a tractor unit 8 via a working hydraulic system. The tractor unit 8 is designed to move the soil tillage device 1 in the working direction R across an agricultural area N. This allows the agricultural area N to be tillaged. The term agricultural area N refers to acres, fields, or meadows for growing agricultural crops.

The tractor unit 8 shown schematically in FIG. 1 is a driverless, autonomous tractor unit 8; however, it can also be a tractor, tow truck, or other tractor unit 8 operated by a driver. Alternatively, the soil tillage device 1 can also be self-propelled, for example, autonomously self-propelled.

The soil tillage device 1 shown in FIG. 1 is a cultivator for non-turning cultivation of the soil of an agricultural area N. Alternatively, the soil tillage device 1 may also be another device, in particular an agricultural device for turning or non-turning soil tillage and/or a seed drill.

The soil tillage device 1 has a tool frame 2 on which several working tools 3 are arranged. In the present embodiment, the working tools 3 are designed as cultivator tines or cultivator coulters, but depending on the design of the soil tillage device 1, they can also be designed as other soil cultivation tools. Alternatively, the working tools 3 can be designed as tine seed coulters and/or as disc-like tools, such as disc coulters, in particular of a disc harrow or double disc coulters of a seed drill. The working tools 3, which are designed as cultivator tines, engage with the agricultural area at a certain depth for soil tillage, thereby causing soil movement and allowing the corresponding part of the agricultural area N to be broken up, turned, or loosened.

In addition to the working tools 3, further devices, tools or units for soil tillage may also be provided optionally, such as coulters, harrows, discs, rollers or levellers. As shown in FIG. 1, several discs for levelling and a roller for reconsolidating the agricultural area N are arranged behind the coulter-like working tools 3 in the working direction R.

When the soil tillage device 1 is moved along the working direction R over the agricultural area N, under unfavorable conditions, material located on the agricultural area N, such as plant residues or soil accumulations, may be dragged along by the working tools 3. The material carried along can accumulate in front of and/or next to the working tools 3 as a material accumulation M, see for example FIG. 2a and b. The material accumulation M can lead to a clogging of the working tools 3, which can impair the overall quality of the soil tillage. In particular, clogging of the working tools 3 due to a material accumulation M can result in uneven soil tillage, which can also lead to undesirable unevenness and/or incomplete tillage of the cultivated agricultural area N.

The soil tillage device 1 has several clogging sensors 4 for the timely detection of material accumulation M being dragged along by the working tools 3. As shown in FIG. 1, the clogging sensors 4 are arranged vertically above the working tools 3 on the machine frame 2. The clogging sensors 4 are coupled to a touch element 4.1 for reliable and rapid tactile detection of material accumulations M. The touch element 4.1 is designed and arranged in such a way that it can be carried along by a material accumulation M.

The basic structure of the clogging sensors 4 and their arrangement on the soil tillage device 1 are explained below with reference to the illustrations in FIGS. 2a and 2b. The touch elements 4.1 of the clogging sensors 4 are lever-like designed and are arranged so that they can move between a normal position P_{N} and a detection position P_{D}. The illustration in FIG. 2a shows the touch elements 4.1 in their normal position P_{N}. As long as a touch element 4.1 is not in contact with a material accumulation M, it is usually in the normal position P_{N}. In the embodiment shown in FIG. 2 a, the touch elements 4.1 are arranged in the normal position P_{N} at an acute angle of attack W to the vertical.

By contact with a material accumulation M the touch element 4.1 is moved into the detection position P_{D}. The illustration in FIG. 2b shows the corresponding touch elements 4.1 in a detection position P_{D}. In this case, the detection position P_{D} differs from the normal position P_{N} in terms of the angle of attack W. The angle of attack W is formed between the touch element 4.1 and the vertical, see FIG. 2a and b. The arrangement of the touch elements 4.1 at an acute angle of attack W to the vertical, as explained above, corresponds to a “drag” arrangement in relation to the working direction R, i.e., the touch elements 4.1 are dragged in the working direction R. Upon contact with a material accumulation M, the touch elements 4.1 tilt at a certain angle against the working direction R, so that they extend approximately perpendicular to the vertical or even beyond in the detection position P_{D}, see FIG. 2b. To reach the detection position P_{D} from the normal position P_{N}, the touch elements 4.1 must be pivoted by an angle of approximately 15°. However, larger or smaller angles may also be provided to reach the detection position.

As can also be seen from the illustrations in FIG. 2a and FIG. 2b, the touch elements 4.1 are spaced apart from the agricultural area N both in the normal position P_{N} and in the detection position P_{D}. This creates a clear passage height and ensures that the soil tillage process of the working tools 3 is not affected by the touch elements 4.1. There is a passage height H between the working tools 3 and the tool frame 2, see FIG. 2a.

In the embodiment shown in FIG. 2a, the vertical distance U between the touch element 4.1 in its normal position and the tool frame 2 is at least one third of the passage height H. The clear passage height of the soil tillage device 1 can be adjusted by selecting the distance U, wherein smaller values of the distance U result in greater clear passage heights. With smaller distances U, material accumulations M can only be detected once they have reached a certain size, in particular a certain height above the agricultural area N. With larger distances U, smaller material accumulations can already be detected, but if the distances U are too large, there is a risk of detection errors due to the detection of regular soil movement or similar. The various touch elements 4.1 of a soil tillage device 1 can all be set to the same distance U or to different distances U.

The structure of a touch element 4.1 is explained below with reference to the illustration in FIG. 6, showing how it is mounted on the soil tillage device 1 according to FIG. 2a and b. The touch element 4.1, which is in the normal position P_{N} according to the illustration in FIG. 6, is designed as a touch lever mounted so that it can pivot about a rotation axis A. The touch lever 4.1 is detachably fastened to a swivel element 4.5 in a manner that is easy to install and maintain, as shown in FIG. 6, by means of a screw connection. The swivel element 4.5 is mounted on a frame connection 5 so that it can pivot about the rotation axis A. The rotation axis A extends essentially transversely to the working direction R. In the embodiment shown in FIG. 6, the touch lever 4.1 is designed arm-like in the manner of a double round tine. Such a design, particularly using smooth round rods, has proven to be advantageous, as it reduces or completely prevents material adhesion. Alternatively, touch levers 4.1 with a different cross-section, such as square or rectangular, can also be used.

As can also be seen in FIG. 6, the clogging sensor 4 is arranged in such a way that it can detect the normal position P_{N} of the touch lever 4.1. For this purpose, a sensor surface of the clogging sensor 4 is aligned with a projection of the swivel element 4.5 in the normal position P_{N}. A stop 9 is provided, against which the swivel element 4.5 strikes in the normal position P_{N}. This stop 9 ensures a defined position of the swivel element 4.5 and thus of the touch lever 4.1 in the normal position P_{N}. In the opposite direction, the swivel element 4.5 can move freely without a stop, thereby implementing a type of overload protection in the event of excessive deflection.

The clogging sensor 4 is designed in particular as a proximity sensor, for example as an inductive or capacitive proximity sensor. Furthermore, distance sensors or push buttons can also be used as clogging sensors 4 if this proves to be advantageous for the respective soil tillage device 1.

In a further embodiment, the clogging sensor 4 can be designed as a rotary angle sensor, in particular as a rotary potentiometer. In such a design, the clogging sensor 4 can be used to detect not only the normal position P_{N} and/or the detection position P_{D}, but also intermediate positions P_{Z} between these two positions. The corresponding intermediate positions can represent different degrees or extents of material accumulation.

As soon as the touch lever 4.1 moves from its normal position P_{N} as a result of contact with a material accumulation M, the projection of the swivel element 4.5 opposite the clogging sensor 4 also moves. The projection moves out of the sensor range of the clogging sensor 4, whereupon a signal is generated which indicates a clogging. Alternatively, a somewhat inverse arrangement is also conceivable, in which the projection of the swivel element 4.5 is located outside the sensor area of the clogging sensor 5 in the normal position P_{N} and enters the sensor area of the clogging sensor 4 when swiveling into the detection position P_{D}.

The touch element 4.1, which is designed as a touch lever, can be moved between the normal position P_{N} and the detection position P_{D} against the force of a tensioned spring 4.2, see FIG. 6. The spring 4.2 can be used to preload the touch lever 4.1 so that minor shocks or vibrations do not cause the touch lever 4.1 to pivot into the detection position P_{D}. The spring 4.2 thus serves as a mechanical filter for vibrations and shocks.

The spring 4.2 is designed as a coil spring and extends between an end of the swivel element 4.5 opposite the touch lever 4.1 and an end of the frame connection 5. An actuating element 4.4 is provided at the end of the spring 4.2 on the frame connection side, via which the preload force of the spring 4.2 can be adjusted. The actuating element 4.4 is designed as an adjusting screw. With a low preload, the touch lever 4.1 can be pivoted from the normal position P_{N} to the detection position P_{D} with comparatively little effort. With a high preload, the force required to pivot the touch lever 4.1 from the normal position P_{N} to the detection position P_{D} increases. Thus, the sensitivity of the touch lever 4.1 and thus of the clogging sensor 4 can be adjusted via the preload of the spring 4.2. The preload can also be used to implement an active movement of the touch lever 4.1, which can be used, for example, to reduce or remove material accumulations M or cloggings.

Instead of a spring 4.2, in particular a mechanical spring, another return element can also be provided to apply a preload to the touch lever 4.1, for example a hydraulic actuating element 4.6, see also FIG. 9b. The hydraulic actuating element 4.6 can perform the functions of a spring and/or an actuator, so that the touch lever 4.1 can be actively moved via the actuator 4.6. This allows material accumulations M to be reduced or removed in the event of a clogging. In this context, it is particularly preferable if the actuator 4.6 is designed to shake or swing the touch lever 4.1 in both directions of rotation about the rotation axis A. For actuation, the actuator 4.6 can be operatively connected to the hydraulic system of the soil tillage device 1 or the tractor unit 8.

The illustration in FIG. 6 also shows that the frame connection 5 is designed as a clamping device. The frame connection 5 allows the clogging sensor 4 and the swivel element 4.5, including the touch element 4.1 attached to it, to be attached to the tool frame 2, in particular to the frame elements 2.1. The frame connection 5 is designed with a clamping element that encompasses the frame connection, corresponding to the respective fastening area of the respective frame element 2.1, see FIG. 3.

The frame connection 5 can be attached to the tool frame 2 in different rotational positions. This allows the angle of attack W of the touch element 4.1 to be changed and/or preset. Furthermore, the distance U between the tool frame 2 and the touch element 4.1 can also be adjusted by means of different rotational positions of the frame connection 5. Alternatively or additionally, the distance U can also be adjusted via the length of the touch element 4.1 and/or via the stop 9. In addition, the frame connection 5 can be moved along the frame elements 2.1 and fastened in different positions.

Two further embodiments of touch elements 4.1 are explained below with reference to the illustrations in FIGS. 7, 8a, and 8b. FIG. 7 essentially shows the double-tined touch element 4.1 already known from FIG. 6. However, the two tines each have an angle at their end facing away from the swivel element 4.5, which leads to a widening of the touch element 4.1 in this area. Such a touch element widening increases the contact area of the touch lever 4.1 with which it can come into contact with material accumulations M. This results in improved response behavior of the clogging sensor 4. In this embodiment, the touch element widening 4.3 is designed as a bending part.

An alternative touch element widening 4.3 is shown in FIGS. 8a and 8b. Based on the touch element 4.1 as shown in FIG. 6, a paddle-shaped element is provided here as the touch element widening 4.3. The paddle-shaped touch element widening 4.3 has a substantially triangular basic shape. The touch element widening 4.3 is attached to the touch element 4.1 in such a way that its wider side is aligned in the direction of the agricultural area N. The touch element widening 4.3 is detachably attached to the end of the double-tined-like touch element 4.1 opposite the swivel element 4.5 by means of a screw connection, see in particular FIG. 8b. In this way, the paddle-like touch element widening 4.3 can be easily and user-friendly removed, for example in the event of wear or damage. The touch element widening 4.3 improves the response behavior of the clogging sensor 4.

As an alternative to triangular, paddle-shaped touch element widening 4.3, other plate-or shield-like elements, for example rectangular, round, or trapezoidal sheet metal elements, can also be used for this purpose.

The following explanation uses the examples in FIGS. 10a and 10b to illustrate how the signals from the clogging sensor 4 can be evaluated and used to control the soil tillage device 1. The clogging sensor 4 is connected to an evaluation unit 7 either by cable or wirelessly, see also FIG. 3. The evaluation unit 7 is used to evaluate the clogging sensor 4. In particular, the evaluation unit 7 can be used to evaluate whether the touch element 4.1 is in the normal position P_{N} or in the detection position P_{D}. If the clogging sensor 4 is designed as a rotary angle sensor, intermediate positions of the touch element 4.1 can also be evaluated via the evaluation unit 7. Furthermore, a touching time D can be evaluated for which the touch element 4.1 is in the detection position P_{D}, the normal position P_{N}, or an intermediate position P_{Z}.

The evaluation unit 7 is designed to generate control signals S, which can be transmitted to a control unit 6 of the soil tillage device 1 and/or to a control system of the tractor unit 8. Preferably, the evaluation unit 7 and the control unit 6 are designed as a structural unit and/or are arranged in a common housing, for example, see FIG. 3.

Depending on the position of the touch element 4.1 and, in particular, depending on the touching time D, different control signals S can be generated by the evaluation unit 7. The different control signals S are adapted to different degrees or extents of material accumulations M or cloggings.

The control signals S that can be generated may be, in particular, warning signals, braking signals, stop signals, raise signals, or lifting signals, but other control signals S are also conceivable. The corresponding control signals S can be autonomously converted by the control unit 6 of the soil tillage device 1 into corresponding actions of the soil tillage device 1.

Alternatively or additionally, the control signals S from a tractor unit 8, in particular an autonomous tractor unit, can be converted into corresponding actions of the tractor unit 8. In the case of a tractor unit 8 operated by personnel, the control signals S can alternatively or additionally be transmitted as instructions or messages to the operating personnel, so that the operating personnel can independently take appropriate measures or be informed of corresponding actions of the soil tillage device 1 and/or tractor unit 8, select from several suggested actions, and/or confirm and/or prevent execution.

The following selected examples illustrate the situations in which different control signals S are generated. In addition to the examples mentioned, various other scenarios are conceivable in which suitable control signals S can also be used.

If only one of several clogging sensors 4 detects a position of the corresponding touch element 4.1 that deviates from the normal position P_{N}, it is likely that there is only a comparatively small material accumulation M with a small spatial extent. In this case, it may be sufficient to reduce the travel speed of the tractor unit 8 for a limited period of time in order to clear the clogging. Once the clogging has been cleared and the touch element 4.1 has returned to the normal position P_{N}, the travel speed can be increased again.

If several adjacent clogging sensors 4 detect positions (e.g., detection positions P_{D}) of the corresponding touch element 4.1 that deviate from the normal position P_{N}, or if a single touch element 4.1 does not return to the normal position P_{N} despite braking, there is usually a more stubborn or larger clogging. In this case, a stop signal can be generated so that the tractor unit 8 and/or the soil tillage device 1 is stopped. Alternatively or additionally, the soil tillage device 1 can be lifted out of the agricultural area N via a lift signal in order to clear the clogging. Furthermore, the working tools 3 can also be lifted individually or in groups, enabling the clogging to be cleared in a targeted manner.

If particularly large-scale or long-lasting cloggings are detected, a driving signal, in particular a reverse signal, can also be generated so that the lifted soil tillage device 1 and/or the tractor unit 8 is moved back in the opposite direction to the working direction R to the point where the clogging was first detected by a clogging sensor 4. Large-area or long-lasting cloggings are detected, for example, when several clogging sensors 4 are in detection position P_{D} and/or when individual or several sensors are in detection position P_{D} for a specified period of time.

In addition or alternatively, warning signals can also be generated, which can be directed in particular to the operating personnel so that they can independently initiate appropriate countermeasures.

Furthermore, active countermeasures can also be controlled at the level of the touch elements 4.1. If a touch element 4.1 is operatively connected to an actuator 4.6, it can be shaken or pivoted via the actuator 4.6, which can reduce some cloggings. Similarly, in some embodiments, the working tools 3 can also be actively controlled individually or in groups and, for example, pivoted in the opposite direction to the working direction R in order to resolve or reduce cloggings.

The illustrations in FIG. 10a and FIG. 11a show examples of a progression of the control signal S of a clogging sensor 4 over time. When the graph assumes the value 1, a control signal S is present, i.e., the corresponding clogging sensor 4 detects a material accumulation M. When the graph has the value 0, no material accumulation M or clogging is detected.

In the diagrams according to FIG. 10b and FIG. 11b, a schematic curve of the towing capacity Z of the tractor unit 8 can be seen, synchronized with the representations according to FIG. 10a and FIG. 11a. As can be seen in the comparison of the respective diagram parts a and b, the clogging sensor 4 detects a clogging or material accumulation M and outputs a corresponding control signal S before the towing capacity Z of the tractor unit 8 increases significantly as a result of the accumulating material. This enables early detection of a clogging or material accumulation M compared to an evaluation of the towing capacity Z of the tractor unit 8. The required towing capacity Z may increase, for example, due to changes in soil conditions without there being a clogging or material accumulation M. Therefore, according to the invention, reliable detection of a clogging or material accumulation M is achieved and false detection is avoided. The detection of a clogging or material accumulation M is independent of the soil conditions.

The comparison of the diagrams in FIG. 11a and FIG. 11b shows that a control signal S detects a clogging or material accumulation M already one time interval t₁ before the towing capacity Z of the tractor unit 8 begins to increase. This allows an early response and, for example, countermeasures to be taken against the clogging or material accumulation M. Even a large-scale or long-lasting clogging or material accumulation M can be detected in the case of a longer touching time D before a significant increase in the towing capacity Z. Early, reliable detection independent of the ground conditions is possible. An evaluation of the towing capacity Z would only provide sufficient information for an appropriate response after a significantly longer period of time t₂. During this time, suitable countermeasures can already be taken to reduce the material accumulation M when using a clogging sensor 4. The quality of soil tillage can thus be significantly improved with a soil tillage device 1 equipped with a clogging sensor 4. Furthermore, mechanical loads on the soil tillage device 1 and/or the tractor unit 8 can be reduced with the aid of clogging sensors 4.

The structure of the soil tillage device 1 and, in particular, the arrangement of the working tools 3 on the soil tillage device 1 are explained below with reference to the illustrations in FIGS. 3, 4, and 5. As can be seen in particular from the top view in FIG. 5, the working tools 3 are distributed across the working width B of the soil tillage device 1. The working tools 3 form three working rows X₁, X₂, X₃, which are arranged one behind the other in the working direction R. The working tools 3 of adjacent working rows X₁, X₂, X₃ are each offset across the working width B for engagement with unworked agricultural area N. The working tools 3 are each arranged on a frame element 2.1 of the tool frame 2. In the present embodiment, the three frame elements 2.1 extend parallel to each other, see FIG. 5. The arrangement of the working tools 3 and the clogging sensors 4 is asymmetrical to a device longitudinal axis L, but can alternatively also be symmetrical.

The working tools 3 are each connected to the tool frame 2 via an overload protection device. The overload protection allows the working tools 3 to swivel against the working direction R in the event of overloads occurring on the working tools 3, for example due to stones located on the agricultural area N or in its ground. It is conceivable that the overload protection can be used as an active means of removing or reducing material accumulations M.

A clogging sensor 4 is arranged on the frame elements 2.1 between each of the working tools 3, see FIG. 5. The clogging sensors 4 can be connected to the evaluation unit 7 either individually, in groups, or all together.

The soil tillage device 1 described above and the method for tillage of an agricultural area N are characterized in that, even under adverse environmental conditions, reliable and rapid detection of material accumulations M is enabled by contact with the touch element 4.1.

### REFERENCE SIGNS

1 Soil tillage device
2 Tool frame
2.1 Frame element
3 Working tool
4 Clogging sensor
4.1 Touch element/touch lever
4.2 Spring
4.3 Touch element widening
4.4 Actuating element
4.5 Swivel element
4.6 Actuator
5 Frame connection
6 Control unit
7 Evaluation unit
8 Tractor unit
9 Stop
A Rotation axis
B Working width
D Touching time
H Passage height
L Device longitudinal axis
M Material accumulation
N Agricultural area
P_{D} Detection position
P_{N} Normal position
P_{Z} Intermediate position
R Working direction
S Control signal
U Distance
W Angle of attack
X Working row
Z Towing capacity

1. Soil tillage device for tillage of an agricultural area (N), which is movable relative to the agricultural area (N), with a plurality of working tools (3) arranged on a tool frame (2) and engaging with the agricultural area (N), and at least one clogging sensor (4) for detecting material accumulations (M) that are dragged along by the working tools (3) and impair the soil tillage, characterized in that the clogging sensor (4) is coupled to a touch element (4.1) arranged movable relative to the tool frame (2) for tactile detection of the material accumulations (M).

2. Soil tillage device according to claim 1, characterized in that the touch element (4.1) is movably arranged between a normal position (P_{N}) and a detection position (P_{D}) indicating a material accumulation (M).

3. Soil tillage device according to claim 2, characterized in that the touch element (4.1) can be moved into the detection position (P_{D}) by contact with a material accumulation (M).

4. Soil tillage device according to one of claims 2 or 3, characterized in that the clogging sensor (4) is designed for detection of the detection position (P_{D}) and/or the normal position (P_{N}) of the touch element (4.1).

5. Soil tillage device according to one of the preceding claims, characterized in that the touch element (4.1) is operatively connected to an actuator (4.6) for reducing a detected material accumulation (M).

6. Soil tillage device according to one of the preceding claims, characterized in that the touch element (4.1) is designed as a touch lever mounted pivotable about a rotation axis (A).

7. Soil tillage device according to one of claims 5 or 6, characterized in that the actuator (4.6) is designed for active pivoting of the touch element (4.1) about the rotation axis (D).

8. Soil tillage device according to one of claims 2 to 7, characterized in that the clogging sensor (4) for evaluation of the detection position (P_{D}) and/or for monitoring of the touching time (D) within which the touch element (4.1) is in the detection position (P_{D}), is connected to an evaluation unit (7).

9. Soil tillage device according to claim 8, characterized in that the evaluation unit (7) is designed for generation of a control signal(S) that can be transmitted to a control unit (6) of the soil tillage device (1) and/or a tractor unit (8) connected to the soil tillage device (1).

10. Soil tillage device according to claim 9, characterized in that the control signal(S) is designed as a warning signal and/or brake signal and/or stop signal and/or lift signal and/or drive signal depending on the touching time (D).

11. Soil tillage device according to one of the preceding claims, characterized in that the working tools (3) are arranged on the tool frame (2) so that they can pivot against the working direction (R) for overload protection.

12. Soil tillage device according to one of the preceding claims, characterized in that a plurality of clogging sensors (4) for detection of material accumulations (M) are distributed across the working width (B) of the soil tillage device (1).

13. Soil tillage device according to claim 12, characterized in that the clogging sensors (4) are each arranged on frame elements (2.1) of the tool frame (2) next to a respective working tool (3), preferably between two working tools (3).

14. Method for tillage of an agricultural area (N) with a soil tillage device (1) with a on a tool frame (2) arranged plurality of working tools (3), engaging the agricultural area (N) and be movable relative thereto, and at least one clogging sensor (4) for detection of material accumulations (M) dragged along by the working tools (3) and impairing the soil tillage, characterized in that the material accumulations (M) are detected tactilely by a touch element (4.1) which is movably arranged relative to the tool frame (2) and coupled to the clogging sensor (4).

15. Method according to claim 14, characterized in that the soil tillage device (1) is designed according to one of claims 1 to 13.
